(19) United States
(12) Patent Application Publication
(10) Pub. No.: US 2012/0251111 A1
(43) Pub. Date: Oct. 4, 2012

(54) OPTOELECTRONIC WAVELENGTH CONVERTER FOR POLARIZATION MULTIPLEXED OPTICAL SIGNALS

(75) Inventors: Lei XU, PRINCETON, NJ (US); Ting WANG, PRINCETON, NJ (US)

(73) Assignee: NEC LABORATORIES AMERICA, INC., Princeton, NJ (US)

(21) Appl. No.: 13/077,767

(22) Filed: Mar. 31, 2011

(51) Int. Cl. H04J 14/06

(52) U.S. Cl. 398/65

(57) ABSTRACT

A wavelength converter that operates on an optical signal having single or multiplexed polarizations and which exhibits any modulation format.

### FIELD OF DISCLOSURE

This disclosure relates to the field of optical communications and in particular to an optoelectronic wavelength converter for polarization multiplexed optical signals exhibiting any modulation format.

### BACKGROUND OF DISCLOSURE

In contemporary optical fiber communication systems, dense wavelength division multiplexing (DWDM) is frequently employed to support ultra-high-capacity optical transmissions. In some commercial DWDM systems, 160 channels at different wavelengths are utilized to support multi-Tb/s optical transmission via a single strand of optical fiber.

In a DWDM-based optical network, optical signals at different wavelengths may conveniently be routed to different destinations. In certain situations however, optical signals having the same wavelength—from different network nodes—may have to pass through the same strand of optical fiber at the same time. As may be readily appreciated, a contention exists for the fiber strand in such a situation.

One solution to this contention scenario is to change the wavelength of one of the optical signals to avoid the contention i.e., wavelength conversion. In certain other scenarios, an optical signal at a particular wavelength may have to pass through an optical DWDM component that does not have an available port supporting that particular wavelength. Accordingly, wavelength conversion permits more efficient utilization of these DWDM components.

Generally speaking, wavelength conversion involves two different approaches namely all-optical wavelength conversion and optoelectronic wavelength conversion.

All-optical wavelength converters generally exploit nonlinear processes in optical fibers, semiconductor devices or waveguides, to convert a data modulation of an incoming signal to an output signal exhibiting different wavelengths. Unfortunately however, due in part to the low conversion efficiency and the non-ideal response of the nonlinear processes responsible for wavelength conversion, all-optical wavelength converters exhibit undesirable system performance characteristics namely signal distortions and a degradation of optical-signal-to-noise ratio.

Recent attempts at all-optical modulation-format-independent wavelength conversion has been described—for example—by X. Yi, R. Yu, J. Kurumida, and S. J. B. Yoo in a paper entitled “Modulation-format-independent wavelength conversion,” which was presented at OFC/NFOEC 2009, paper PDPC8. In the approach described therein, coherent optical interference is used to generate four output ports, and an all-optical IQ modulator is used to perform the wavelength conversion as a result the non-linear processes within the all-optical modulator.

Optoelectronic wavelength converters are a technically mature approach to wavelength conversion and are based on an opto-electrical-optical conversion process wherein incoming optical signals are converted to electrical signals and these electrical signals are then converted back to optical signals. The electrical signal may be used to modulate a laser output at different wavelengths to achieve the optical wavelength conversion. One typical approach to optoelectronic wavelength conversion is characterized by a back-to-back electronic connection of an optical transceiver. As compared to the all-optical wavelength conversion, optoelectronic wavelength conversion is based on mature technologies and generally produces a better system performance. As recognized in the art however, the contemporary optoelectronic wavelength converters are unfortunately dependent on signal modulation format.

Notwithstanding these developments, alternative approaches to wavelength conversion would represent a significant advance in the art.

### SUMMARY OF DISCLOSURE

An advance is made in the art according to an aspect of the present disclosure directed to an optoelectronic wavelength converter for polarization multiplexed optical signals exhibiting any modulation format.

The wavelength converter according to the present disclosure employs coherent detection and dual polarization I/Q modulations, has simplified electronic processing and exhibits a large dynamic wavelength range for a number of practical applications.

Of further advantage wavelength converters according to the present disclosure may advantageously employ commercially available technologies and devices, and exhibit a simplified design, high reliability and a large dynamic wavelength range.

### BRIEF DESCRIPTION OF THE DRAWING

A more complete understanding of the disclosure may be realized by reference to the accompanying drawing in which:

FIG. 1 is a schematic block diagram depicting an overall system architecture according to an aspect of the present disclosure;

FIG. 2 is a schematic diagram depicting an overall system operation according to an aspect of the present disclosure.

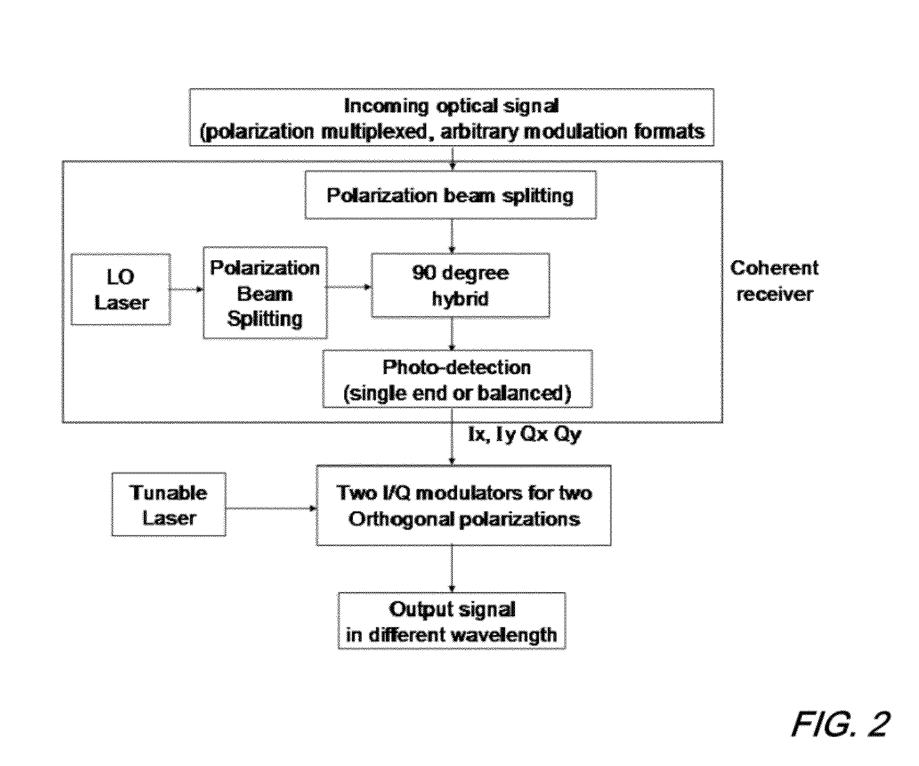

### DESCRIPTION OF EMBODIMENTS

The following merely illustrates the principles of the various embodiments. It will thus be appreciated that those skilled in the art will be able to devise various arrangements which, although not explicitly described or shown herein, embody the principles of the embodiments and are included within their spirit and scope.

Furthermore, all examples and conditional language recited herein are principally intended expressly to be only for pedagogical purposes to aid the reader in understanding the principles of the embodiments and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including any functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the FIGs. are conceptual only. Their function may be carried out through the operation of program logic, through dedicated logic, through the interaction of program control and dedicated logic, or even manually, the particular technique being selectable by the implementer as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent as those shown herein.

Unless otherwise explicitly specified herein, the drawings are not drawn to scale.

As noted previously, a new optoelectronic wavelength converter for polarization multiplexed optical signals which can be in any modulation format(s) is the subject of the present disclosure. Advantageously, the wavelength converter is based on coherent detection and dual polarization I/Q modulations, has simplified electronic processing and exhibits a large dynamic wavelength range for practical applications.

The approach according to the present disclosure advantageously is based on commercially available technologies and devices, and exhibits further advantages by having simplified design, high reliability and a large dynamic wavelength range as compared with prior art designs. Of further advantage, optical signals input to the wavelength converter may exhibit a single-polarization or a multiplexed-polarization, and the modulation format of the input optical signals can be intensity, phase or QAM modulations.

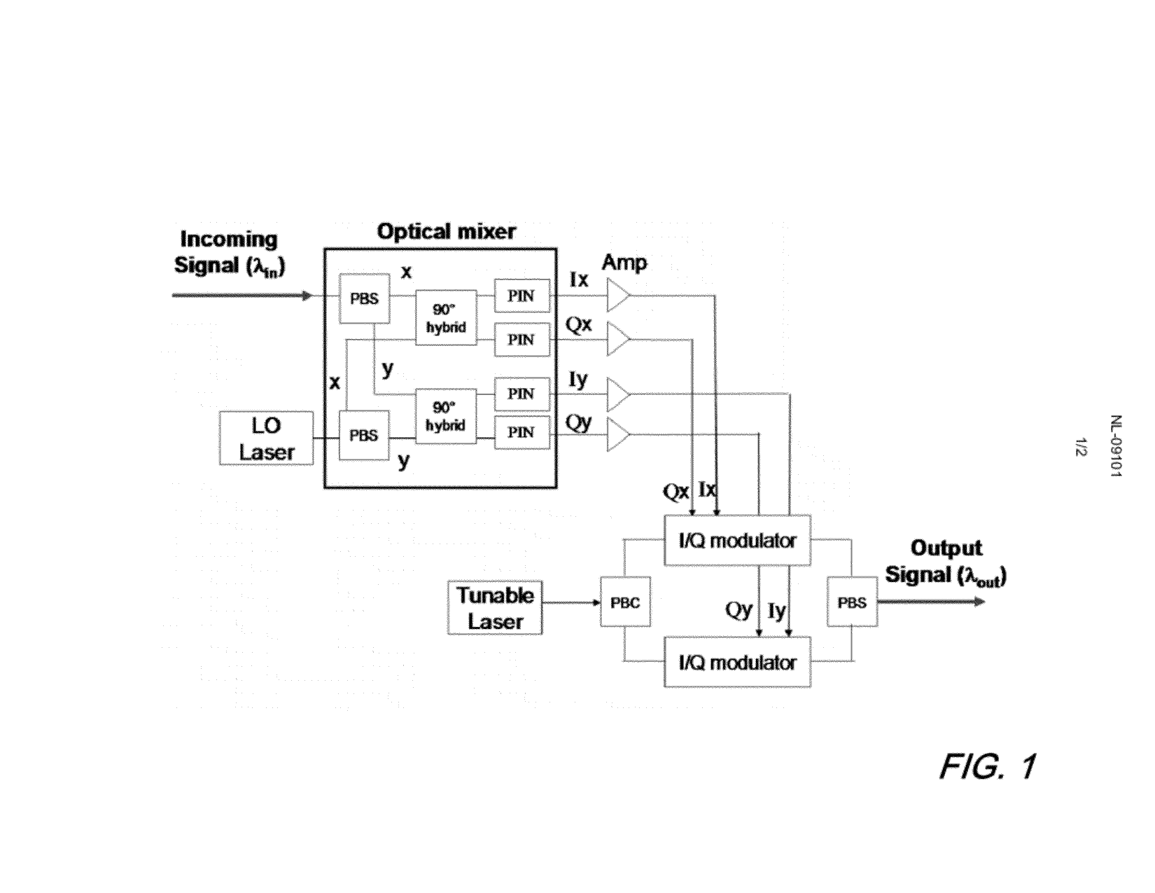

Turning now to FIG. 1, there is shown a schematic block diagram of a wavelength converter according to the present disclosure. As shown in that FIG. 1, the wavelength conversion generally involves (1) coherent detection and (2) dual-polarization I/Q modulation.

More particularly coherent detection involves the interference of an incoming signal with a local oscillator (LO) laser within an optical mixer. As may be appreciated by those skilled in the art, the LO laser output wavelength is preferably close to a central wavelength of the incoming signal. Advantageously, homodyne, intradyne or heterodyne detections may be employed for coherent detection.

With continued reference to FIG. 1, it may be observed that the optical mixer device includes two polarization beam splitters (PBS), and two 90 degree hybrids. The incoming optical signal is split through the effect of a first PBS into an X polarization signal and a Y polarization signal. Similarly, the output of the LO laser—which is preferably polarized—is applied to a second PBS such that the polarization angle relative to the PBS is 45 degree causing the LO laser light to be evenly split into X and Y polarizations. The X polarization signal from the input signal and the X polarization of the LO laser are applied to a 90 degree hybrid. The Y polarization signal from the input signal and the Y polarization of the LO laser are applied to a second 90 degree hybrid. The 90 degree hybrid devices cause the interference of the two signals and generates the in (I) phase and quadrature (Q) phase signals (Ix, Qx, Iy, Qy).

As may be understood, the four signals so produced are converted to electrical signals by—for example PIN photodiodes—and the resulting electrical signals designated as Ix, Qx, Iy, Qy in FIG. 1 and which convey amplitude and phase information of the incoming optical signals are amplified and applied to an I/Q modulator.

More particularly, the Qx and Ix electrical signals are applied to a first I/Q modulator while the Qy and Iy electrical signals are applied to a second I/Q modulator. The modulators are driven by a tunable laser output which is first split and then applied to the modulators. The output of the two I/Q modulators are combined through the effect of a Polarization Beam Combiner and the resulting optical output signal is output. The wavelength of the output signal is determined by the tunable laser.

Advantageously, the wavelength converter described according to the present disclosure may process optical signals exhibiting single or dual polarizations. Of further advantage, the optical signals so converted may exhibit any modulation format. Still further, the components are readily fabricated and commercially available optoelectronic IQ modulators, i.e., LiNbO3 modulators may advantageously be used.

Notably, any distortions of the incoming optical signal, the phase noise from the LO laser and the frequency offset between the incoming signal and the LO signal are also transferred to the newly generated wavelength-converted signal. All of the signal distortion effects may be compensated when the wavelength converted signals are detected.

At this point, while we have discussed and described the invention using some specific examples, those skilled in the art will recognize that our teachings are not so limited. Accordingly, the invention should be only limited by the scope of the claims attached hereto.

1. A wavelength converter comprising:
an optical mixer which receives an incoming optical signal at a particular wavelength and produces four in-phase (I) and quadrature-phase (Q) output signals (Ix, Qx, Iy, Qy);
a dual-polarization I/Q modulator which receives the four output signals and generates an output optical signal at a wavelength different from the input wavelength.

2. The wavelength converter of claim 1 wherein said I/Q modulator further comprises:
a pair of LiNbO3 I/Q modulators which receive the Qx, Ix and Qy, Iy signals respectively, each producing a respective output signal which are combined into the output optical signal.

3. The wavelength converter of claim 1 wherein said input optical signal exhibits an arbitrary modulation formation and is one of a type selected from the group consisting of polarization multiplexed and single polarization.
